(19) United States
(12) Patent Application Publication
(10) Pub. No.: US 2003/0080850 A1
(43) Pub. Date: May 1, 2003

(54) Method and apparatus for causing a remote device to implement a user profile and system that operates therewith

(76) Inventor: David R. Kline, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/016,315

(22) Filed: Oct. 30, 2001

(51) Int. Cl. G06F 7/00

(52) U.S. Cl. 340/5.6

(57) ABSTRACT

An electronic apparatus is disclosed. The apparatus comprises a housing that a person can carry and a circuit coupled to the housing. The circuit causes a device to operate according to a predetermined user profile of the person, wherein the device is remote from the housing and the circuit. The device can be used in a system that also includes the device that, when remote from the electronic apparatus, stores a first predetermined user profile of a first person, detects the first electronic apparatus, and operates according to the first user profile in response to detecting the electronic apparatus.

### BACKGROUND OF THE INVENTION

1. Field of the Invention

The invention relates generally to electronic equipment, and more particularly to an apparatus for causing a remote device to implement a user profile, to the remote device, and to related systems and methods.

2. Description of the Background Art

Electronic devices today can store profiles of user preferences and recall selected profiles on demand. For example, some automobiles allow a driver to program an onboard computer with his preferences, such as the position of the driver's seat, tilt of the steering wheel, angle of the mirrors, interior temperature, and favorite radio stations. The computer then stores these preferences as the driver's preference profile. Once the computer stores the profile, the driver need only push a button or take some other simple action whenever he or she wants the automobile to recall the profile. Because profile storing removes the need for a driver to manually reset the seat position, etc. after another driver has driven the automobile, such profile storing can save the driver time, particularly if there are multiple drivers sharing the same automobile. Other devices that allow a user to program and store his preference profile include televisions, stereos, and other electronic equipment.

Typically, a user must manually configure such a device according to his preferences and then cause the device to save the resulting preference profile before the profile can be recalled with “the touch of a button.” For example, a driver typically programs an automobile computer with his preferences by manually positioning the driver's seat, angling the mirrors, setting the interior temperature, selecting a favorite radio station, and then instructing the computer to save these preferences as a recallable profile. Thereafter, the driver can recall the profile by pushing a button or taking some other action as discussed above.

Unfortunately, manually configuring such a device can be inconvenient. Additionally, the ability to recall a stored profile can lose its advantages if too many people use the device or if a person uses multiple devices. For example, manually positioning a driver's seat to program an automobile computer with a driver's profile can take a few minutes. If the computer can store two profiles, and no more than two drivers share the automobile, then the inconvenience of performing the manual configuration is minimized since the driver need only perform this manual set up once. However, if three or more drivers share the subject automobile, then at least one of the drivers will be unable to store a profile. Consequently, this driver will have to manually position the driver's seat, etc., whenever the automobile has been configured according to another driver's profile. Furthermore, if a driver uses different automobiles on a regular basis—as might a frequent traveler who rents automobiles—the ability to store a profile is of little advantage since the driver must manually configure each automobile at least once. And even if the driver stores a profile in each automobile used, the driver may never have occasion to recall his profile, particularly if he or she rarely or never uses the same automobile more than once.

In addition, manually recalling a stored profile may be inconvenient as well. For example, suppose that to recall a profile, a driver must push a button mounted to the dashboard that cannot be reached from any location other than the driver's seat. If the previous driver is shorter than the current driver, then the current driver may have to squeeze into the driver's seat to push the button, and thus may experience discomfort until the seat moves into the driver's preferred position.

### SUMMARY OF THE INVENTION

In one aspect of the invention, an electronic apparatus is carried by a person and causes a device to recall the person's profile. The apparatus may download the person's profile into the device, or the person may have previously loaded his profile into the device.

In another aspect of the invention, the device stores the person's profile, detects the electronic apparatus as it is being carried by the person, and recalls the profile in response to receiving a signal from or otherwise detecting the apparatus.

In yet another aspect of the invention, where the person has previously stored his profile in the device, the electronic apparatus causes the device to automatically recall the person's profile, thus eliminating the need for the person to manually recall his profile. For example, the apparatus can cause an automobile to automatically recall a driver's profile when the driver nears his automobile such that the seat moves into the profile position before the driver sits down.

In addition, where the electronic apparatus provides the person's profile to the device, the person need not manually configure the device to program it with his profile. For example, the apparatus can automatically download the driver's profile to a rental car as the driver nears the car, and then cause the car to recall the profile before the driver sits down.

### BRIEF DESCRIPTION OF THE DRAWINGS

FIG. 1 is a view of a driver carrying an electronic apparatus and an automobile that recalls the driver's profile in response to the apparatus according to an embodiment of the invention.

FIG. 2 is a view of a person carrying an electronic apparatus and a television that recalls the person's profile in response to the apparatus according to an embodiment of the invention.

FIG. 3 is a view of a person carrying an electronic apparatus and a base unit that causes one or more devices to recall the person's respective profiles in response to the apparatus according to an embodiment of the invention.

FIG. 4 is a view of a person carrying an electronic apparatus and a vending machine that displays selections according to the person's profile in response to the apparatus according to an embodiment of the invention.

FIG. 5 is a schematic block diagram of the circuitry within the electronic apparatus of FIGS. 1-4 and the circuitry within the profile circuits of the automobile of FIG. 1, the television of FIG. 2, the base unit of FIG. 3, and the vending machine of FIG. 4 according to an embodiment of the invention.

### DESCRIPTION OF THE PREFERRED EMBODIMENTS

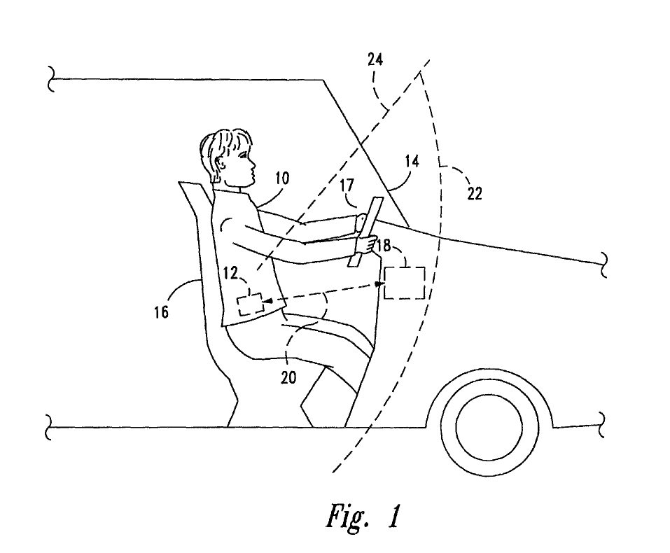

FIG. 1 is a view of a driver 10 carrying an electronic apparatus 12, and an automobile 14 that recalls the driver's profile in response to the apparatus according to an embodiment of the invention. The apparatus 12 causes the automobile 14 to recall the profile of the driver 10, thus eliminating the need for the driver 10 to manually recall his profile. In addition, the apparatus 12 may also provide the driver's profile to the automobile 14, thus eliminating the need for the driver 10 to manually configure the automobile according to his preferences and then cause the automobile to save these preferences as his profile.

The electronic apparatus 12 can be a portable apparatus such as a PDA that the driver 10 carries in his pocket. Alternatively, the apparatus 12 can be a laptop computer or any other apparatus that the driver 10 can carry and that operates as discussed herein. In one embodiment, the apparatus 12 signals the automobile 14 to recall the driver's profile, which the driver 10 has previously programmed into or otherwise provided to the automobile. In a related embodiment, the apparatus 12 also downloads the driver's profile to the automobile 14. In this embodiment, the driver 10 programs the apparatus 12 with his profile for the automobile 14. The programming details can be in accordance with menu-driven keystrokes, or in accordance with other user input techniques. Alternatively, the apparatus 12 may include a port (not shown) that allows the driver 10 to connect a computer (not shown) to the apparatus and to download the automobile profile to the apparatus from the computer.

The automobile 14 includes a driver's seat 16, a steering wheel 17, and a profile circuit 18, which causes the automobile to recall the profile of the driver 10 in response to the apparatus 12. The driver 10 may manually program or download his profile into the circuit 18 using a dashboard keypad (not shown) or other conventional technique. Alternatively, the apparatus 12 may download the driver's profile to the circuit 18 and then cause the circuit to recall the profile. Typically, the circuit 18 communicates with the seat, mirror, climate, and other controls (not shown) via a cable (not shown) or other means so that it can set these controls according to the preferences included in the driver's profile.

The apparatus 12 and circuit 18 communicate over a path 20, which may be any type of wireless or a cabled (wired) path. Where the path 20 is wireless, the apparatus 12 and circuit 18 may communicate using conventional radio-wave protocols such as the 2.4 GHz Bluetooth protocol or may use conventional infrared protocols such as those used with television remote controls (not shown). Where infrared is used, a direct, preferably unobstructed path between the apparatus 12 and circuit 18 is typically required for successful communication. Where the path 20 is cabled, it may include a standard wire cable or a fiber-optic cable (not shown).

In operation, the electronic apparatus 12 and the circuit 18 establish communication with one another when a PAN 22 of the driver 10 intersects with the circuit 18, that is, when the circuit 18 enters the driver's personal area network (PAN). Where the path 20 is wireless, the PAN 22 is akin to a “bubble” that is centered around the driver 10 and has a predetermined radius 24 that depends on the device, such as the automobile 14. For example, the radius 24 may be one foot or less for the automobile 14 so that equipment carried by other persons (not shown) not seated in the driver's seat 16 do not cause the circuit 18 to recall a profile other than the driver's profile.

Interaction between the apparatus 12 and the circuit 18 commences when the circuit enters the driver's PAN 22, typically when the driver 10 sits in the driver's seat 16. For example, the apparatus 12 may detect the circuit 18 before the circuit enters the driver's PAN 22, determine when the circuit enters the driver's PAN, and then initiate communication with the circuit. Or the circuit 18 may detect the apparatus 12 before the circuit enters the driver's PAN 22, determine when it enters the driver's PAN, and then initiate communication with the apparatus. Moreover, the driver 10 may initiate communication between the apparatus 12 and circuit 18 via an interface such as a keyboard (not shown) on the apparatus or circuit. Where the path 20 is cabled, the circuit 18 typically enters the drivers PAN 22 when the driver 10 or another person (not shown) connects the apparatus 12 to the circuit with a cable (not shown). Communication between the apparatus 12 and circuit 18 may commence automatically with the connection of the cable, or may be initiated by the driver 10 via an interface such as a keyboard on the apparatus or circuit. Furthermore, although the PAN 22 is shown as being spherical, it may have another shape.

Once communication between the apparatus 12 and circuit 18 is established, the circuit 18 recalls the driver's profile by configuring the automobile 14 according to the profile. If the driver 10 has previously loaded his profile into the circuit 18, then the apparatus 12 identifies the driver 10. In response to this identification, the circuit 18 recalls the profile corresponding to the driver by setting the driver's seat 16, mirrors (not shown), steering wheel 17, radio (not shown), etc. to the positions or settings specified by the recalled profile. If the driver 10 has not previously loaded his profile into the circuit 18, then the circuit notifies the apparatus 12 that it has stored no profile corresponding to the driver 10. In response, the apparatus 12 downloads the driver's profile to the circuit 18, which, after the download is complete, recalls the profile as discussed above. If, however, the apparatus 12 cannot download the driver's profile or the driver has not programmed his profile into the apparatus, then the driver 10 loads his profile into the circuit 18 via an interface such as a dashboard keypad (not shown) or via other means. Alternatively, the driver 10 may load his profile into the apparatus 12, which then can download the profile to the circuit 18.

There are a number of ways to reduce the possibility of the profile circuit 18 recalling the profile of another person (not shown) who is near the automobile 14 and carrying a profile apparatus similar to the apparatus 12. As discussed above, the PAN 22 of the driver 10 may be sized so that it only intersects the profile circuit 18 when the driver is sitting in the driver's seat 16. Consequently, the PANs of passengers (not shown) will not intersect the circuit 18. Alternatively, the apparatus 12 may require the driver 10 to push a button or take some other action before it causes the circuit 18 to recall the driver's profile. Or, where multiple device similar to apparatus 12 are within range, the circuit 18 or apparatus 12 may have the capability to determine which apparatus 12 is closest to the driver 10—or other driver (not shown) sitting in the driver's seat 16—such that the circuit 18 recalls only the profile of the driver identified by the closest apparatus.

Alternatively, the profile circuit 18 may recall a profile that is the combination of the profiles of the driver 10 and a passenger (not shown) who is carrying a profile apparatus similar to the apparatus 12. In one embodiment, the circuit 18 can recall a combination profile for non-driver-specific preferences such as the temperature inside the automobile 14. For example, suppose that the driver 10 prefers the temperature to be between 65°-70° Fahrenheit (F), and the passenger prefers the temperature to be between 68°-73° F. The circuit 18 recognizes that these two ranges overlap between 68°-70° F., and thus recalls a combination profile by configuring the automobile 14 to maintain the temperature between 68°-70° F. Thus, the circuit 18 recalls a profile that satisfies the temperature preferences of both the driver 10 and the passenger. Similarly, the circuit 18 can recall a combination profile that causes the automobile radio (not shown) to play only stations that are common to the profiles of the driver 10 and the passenger.

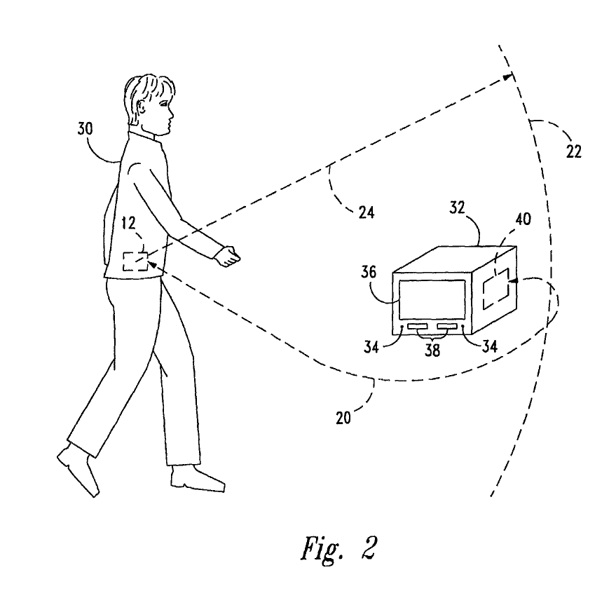

FIG. 2 is a view of a person 30 carrying the electronic profile apparatus 12 and of a television 32 that recalls the person's profile in response to the apparatus according to an embodiment of the invention. Like numbers are used to reference components similar to those in FIG. 1. In a manner that accords with described above in conjunction with FIG. 1, the apparatus 12 causes the television 32 to recall the viewing profile of the person 30, thus eliminating the need for the person to manually recall a profile. In addition, the apparatus 12 may also provide the person's profile to the television 32, thus eliminating the need for the person 30 to manually configure the television with his preferences and then cause the television to store these preferences as his profile.

The television 32 includes controls 34, a display screen 36, speakers 38, and a profile circuit 40, which may be similar to the profile circuit 18 of FIG. 1 and which causes the television to recall the profile of the person 30 in response to the apparatus 12. The person 30 may manually program his profile into the circuit 40 using the controls 34 or other conventional means. Alternatively, the apparatus 12 may download the person's profile to the circuit 40 and then cause the circuit to recall the profile. Typically, the circuit 40 conventionally communicates with other circuits (not shown) within the television 32 so that it can set these circuits according to the preferences included in the person's profile. The person's profile may include, e.g., preferred volume and brightness settings, a preferred channel for viewing at a particular time of day, and a preferred group of television channels available for viewing. For example, the person 30 may prefer to watch the channel-five news at six o'clock on weeknights. Also, if the person 30 is a minor, his preferred group of television channels may omit channels that his parents (not shown) forbid him to view.

In operation, the profile apparatus 12 and the circuit 40 establish communication with one another when the PAN 22 of the person 30 intersects with the circuit 40 as discussed above in conjunction with FIG. 1. The radius 24 of the PAN 22 can be any practical length, for example between five and ten feet.

Once communication between the apparatus 12 and circuit 40 is established, the circuit 40 recalls the person's profile by configuring the television 34 according to the profile. If the person 30 has previously loaded his profile into the circuit 40, then the apparatus 12 identifies the person 30. In response to this identification, the circuit 40 recalls the profile corresponding to the person 30 by setting the volume, picture, channel selection, etc. to the settings specified by the recalled profile. If the person 30 has not previously loaded his profile into the circuit 40, then the circuit notifies the apparatus 12 that it has stored no profile corresponding to the person 30. In response, the apparatus 12 downloads the person's profile to the circuit 40, which, after the download is complete, recalls the profile as discussed above. If, however, the apparatus 12 cannot download the person's profile or the person has not programmed his profile into the apparatus, then the person 30 preferably loads an appropriate profile into the circuit 40 via the controls 34 or via other means. Alternatively, the person 30 may load his profile into the apparatus 12, which then can download the profile to the circuit 40.

There are a number of ways to resolve conflicts when the PANs of multiple persons carrying apparatus 12 intersect with the circuit 40. For example, the circuit 40 may recall the profile of the person closest to the television 32. Alternatively, the apparatus 12 may require the person 30 to push a button (not shown) or take some other action before it causes the circuit 40 to recall the person's profile. Or, the person's profile can include a priority designation that the circuit 40 uses to determine which profile to recall in case of a conflict. For example, a parent may have priority over a child (not shown), and thus the parent or child's profiles may indicate this priority. Therefore, if the PANs of both parent and child—assuming of course that both parent and child are carrying a respective apparatus 12—simultaneously intersect the circuit 40, the circuit recalls the parent's profile because the parent has viewing priority over the child. Alternatively, the circuit 40 may recall a profile that is the combination of the profiles of persons (only the person 30 shown) carrying apparatus 12 and whose PANs intersect the circuit 40. For example, the circuit 40 may recall a combination profile that enables the television 32 to display only the channels that are included as viewable in the profiles of all these persons. Therefore, if a child is one of the persons, the circuit 40 will disable the television 32 from displaying any channels that the child's parents (not shown) have omitted from his profile.

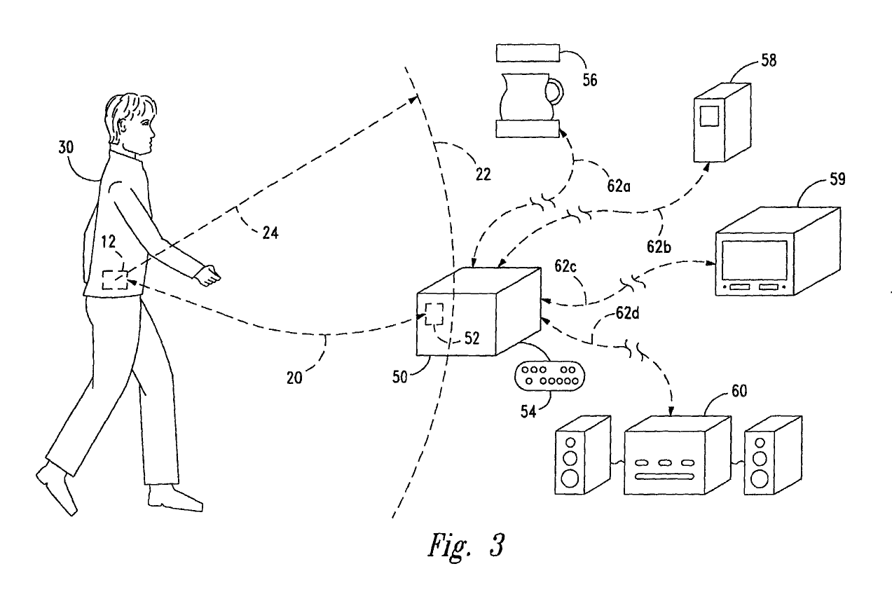

Although discussed in conjunction with the television 32, the profile apparatus 12 and profile circuit 40 can operate similarly where the circuit 40 is included in another electronic appliance or device such as a stereo or coffee maker (FIG. 3).

FIG. 3 is a view of the person 30 carrying the electronic profile apparatus 12, and of a base unit 50 that causes each of one or more satellite devices to recall the person's respective profile in response to the apparatus according to an embodiment of the invention. Like numbers are used to reference components similar to those in FIGS. 1 and 2. The base unit 50 allows the apparatus 12 to communicate with a single unit instead of each individual device. The apparatus 12, via the base unit 50, causes each of the devices to recall the respective profile of the person 30, thus eliminating the need for the person to manually recall his profiles. In addition, the apparatus 12 may also provide the person's profiles to the base unit 50, which provides them to the respective devices. This eliminates the need for the person 30 to manually configure the devices with his preferences and then cause the devices to save these preferences as his respective profiles.

The base unit 50 includes a profile circuit 52, which may be similar to the profile circuits 18 and 40 of FIGS. 1 and 2, respectively, and which, in response to the apparatus 12, causes each of the devices to recall the respective profile of the person 30. In one embodiment, the base unit 50 is a computer that includes a key board 54. The person 30 may manually load his profiles into the base unit 50 using the key board 54 or other conventional means. Alternatively, the apparatus 12 may download the person's profiles to the circuit 52, which in turn downloads the profiles to the respective devices or otherwise causes the devices to operate according to the respective profiles. Or, the apparatus 12 may download the profiles directly to the respective devices.

The satellite devices with which the base unit 50 communicates are typically programmable with user preferences, and can include a coffee maker 56, furnace/air conditioner 58, television 59, and stereo 60. The person's profile for the coffee maker 56 can include such preferences as a morning turn-on time and coffee strength. The person's profile for the furnace/air conditioner 58 can include such preferences as the temperature throughout the house or in the room where the base unit 50 is located. And the person's profile for the stereo 60 can include such preferences as favorite radio stations, bass, treble, and sound settings, and sound configuration. Although these devices are programmable, they may each be unable to store more than one set of preference, i.e., profile. Therefore, in this situation the base unit 50 can store multiple profiles for each device, and download the profiles of the person 30 in response to the apparatus 12.

The profile circuit 52 of the base unit 50 and the devices 56, 58, 59, and 60 communicate over respective paths 62a-62d, which each may be any type of wireless or cabled path. Where a path 62 is wireless, the circuit 52 and respective device may communicate using conventional radio-wave protocols such as the 2.4 GHz Bluetooth protocol or may use conventional infrared protocols such as those used with television remote controls (not shown). Where infrared is used, a direct, unobstructed path between the base unit 50 and the respective device is typically required for successful communication. Where a path 62 is cabled, it may include a standard wire cable or a fiber-optic cable, or may include a home's electrical wiring (not shown) and the power cords (not shown) of the base unit 50 and respective device.

In operation, the profile apparatus 12 and the profile circuit 52 of the base unit 50 establish communication with one another when the PAN 22 of the person 30 intersects with the circuit 52 as discussed above in conjunction with FIGS. 1 and 2. The radius 24 of the PAN 22 can be any practical length. For example, because the base unit 50 can control devices throughout a home (not shown) and the base unit 50 can be located in any room of the home, a radius equal to the longest dimension of the home insures that the circuit 52 recalls the person's profiles regardless of his location within the home.

Once communication between the apparatus 12 and circuit 52 is established, the circuit 52 causes the devices 56, 58, 59, and 60 to recall the respective profiles of the person 30. If the person 30 has previously loaded his profile or profiles into the circuit 52 or the devices 56, 58, 59, and 60, then the apparatus 12 identifies the person 30. In response to this identification, the circuit 52 causes the devices to recall the respective profiles corresponding to the person 30. If the person 30 has not previously loaded his profile or profiles into the circuit 52 or the devices 56, 58, 59, and 60, then the circuit 52 notifies the apparatus 12 that no profiles are stored corresponding to the person 30. In response, the apparatus 12 downloads the person's profiles to the circuit 52 or directly to the devices 56, 58, 59, and 60. After the download is complete, the circuit 52 causes the devices to recall the respective profiles as discussed above. If, however, the apparatus 12 cannot download the person's profiles or if the person has not loaded his profile into the apparatus, then the person 30 loads his profile into the circuit 52 or devices 56, 58, 59, and 60 via an interface or respective interfaces (not shown) or via other means. Alternatively, the person 30 may load his profile into the apparatus 12, which then can download the profile to the circuit 52 or to the devices 56, 58, 59, and 60 as discussed above.

There are a number of ways to resolve conflicts when the PANs of multiple persons carrying apparatus 12 intersect with the circuit 52. For example, the circuit 52 may recall the respective profile of the person closest to a particular device. That is, the circuit 52 may recall the stereo profile of the person standing closest to the stereo 60, where the apparatus 12 and base unit 50 can use conventional techniques to determine which person is closest to a particular device. Alternatively, the apparatus 12 or base unit 50 may require the person 30 to push a button (not shown) or take some other action before the apparatus 12 causes the circuit 52 to recall the person's profiles. Or, the person's profiles can include a priority designation that the circuit 52 uses to determine which person's profiles to recall in case of a conflict. For example, a parent may have priority over a child (not shown), and thus the parent or child's profiles may indicate this. Therefore, if the PANs of both parent and child—assuming of course that both parent and child are carrying a respective apparatus 12—simultaneously intersect the circuit 52, the circuit 52 causes one or more of the devices 56, 58, 59, and 60 to recall the parent's respective profiles because the parent has priority over the child. In addition, the circuit 52 may recall a combination profile as discussed above in conjunction with FIGS. 1 and 2.

Although discussed in conjunction with devices that do not include profile circuits, the coffee maker 56, furnace/air conditioner 58, television 59, and stereo 60 may each include a profile circuit such as the circuit 40 of FIG. 2 and operate similarly to the television 32 of FIG. 2 except for communicating with the apparatus 12 via the base unit 50. Furthermore, other programmable electronic appliances or devices can be coupled to and controlled by the base unit 50 as discussed above.

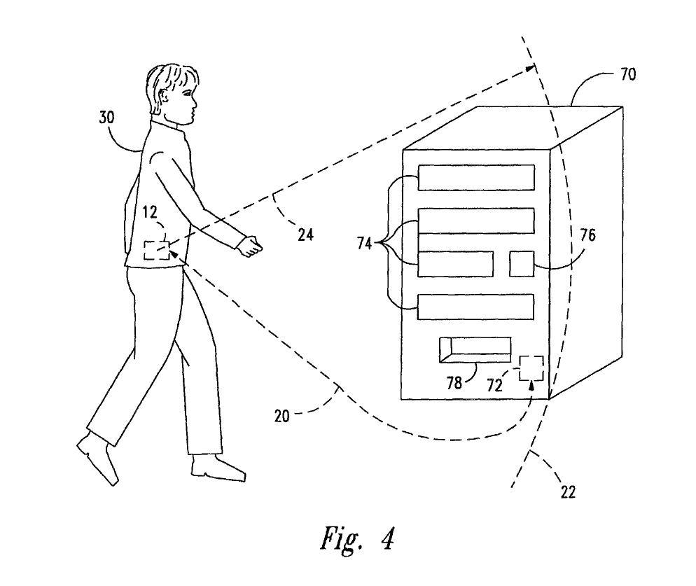

FIG. 4 is a view of the person 30 carrying the electronic profile apparatus 12 and of a vending machine 70 that recalls the person's profile in response to the apparatus according to an embodiment of the invention. Like numbers are used to reference components similar to those in FIGS. 1-3. The apparatus 12 causes the vending machine 70 to recall a product-selection profile of the person 30, thus facilitating the person's viewing and selection of products offered by the machine 70. For example, if the person 30 is a diabetic and has a diabetic profile, the machine 70 may display only low-sugar or sugar-free selections. Implementing such product-selection profile often saves the person 30 time because he or she need not view products in which he or she has no interest.

The vending machine 70 includes a profile circuit 72 that can be similar to the circuit 40 of FIG. 2, product-display windows 74, a payment/selection interface 76 for accepting currency or credit cards (not shown) and allowing the person 30 to select a product, and a product-dispense port 78. Because the vending machine 70 is intended for public use and the person 30 may use the machine 70 infrequently, it is often impractical to allow the person 30 to manually load his profile into the circuit 72, although allowing such manual loading is contemplated. Instead, the apparatus 12 typically downloads the person's profile to the circuit 72 and then causes the circuit to recall the profile.

In operation, the profile apparatus 12 and the circuit 72 establish communication with one another when the PAN 22 of the person 30 intersects with the circuit 72 as discussed above in conjunction with FIGS. 1 and 2. The radius 24 of the PAN 22 can be any practical length, for example between one and five feet.

Once communication between the apparatus 12 and circuit 72 is established, the circuit 72 configures the vending machine 70 to display its selection according to the profile of the person 30. Typically, the apparatus 12 downloads the person's profile to the circuit 72, which, after the download is complete, recalls the profile as discussed above.

After the vending machine 70 displays the profiled selection of products, the person 30 selects and pays for the desired product or products via the interface 76, and retrieves the selected product or products from the port 78.

The apparatus 12 and circuit 72 can implement conventional techniques such as those discussed above in conjunction with FIGS. 1-3 to resolve conflicts that arise when the PANs of multiple persons carrying apparatus 12 intersect with the circuit 72.

Furthermore, to conserve memory space, the vending machine 70 may delete the person's profile after the person 30 has finished selecting products for purchase. For example, the circuit 72 may delete the profile a predetermined time after the person 30 makes his selection, when the person's PAN 22 no longer intersects the circuit 72, or when another person's PAN intersects the circuit 72.

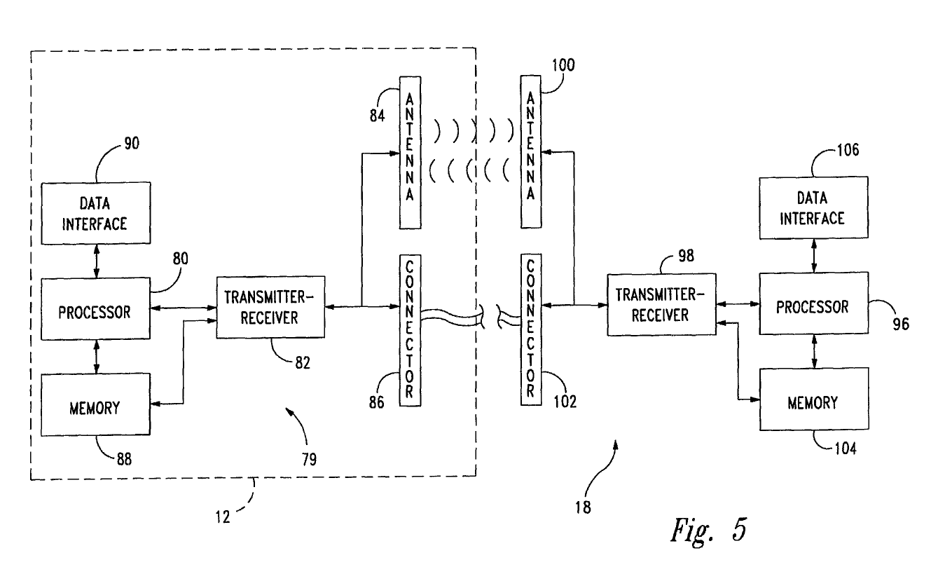

FIG. 5 is a schematic block diagram of circuitry 79 within the apparatus 12 of FIGS. 1-4 and of the profile circuit 18 of FIG. 1, it being understood that the profile circuits 40, 52, and 72 of FIGS. 2-4 can be similar the to circuit 18.

The circuitry 79 includes a processor 80, a transmitter/receiver 82 that interfaces the processor with an antenna 84 or connector 86, a memory 88, and an optional data interface 90 such as a key pad or touch screen. The processor 80 provides the identity of a person (not shown in FIG. 5) wearing the apparatus 12 to the circuit 18 or otherwise causes the circuit 18 to recall the person's profile as discussed above in conjunction with FIGS. 1-4. If communication is via a wireless path 92, then the processor 80 communicates with the circuit 18 via the transmitter/receiver 82 and the antenna 84; if communication is via a cabled path 94, then the processor communicates with the circuit 18 via the transmitter/receiver 82 and the connector 86. The processor 80 can also cause the apparatus 12 to perform the other functions described above in conjunction with FIGS. 1-4 such as determining how far the person wearing the apparatus 12 is from the circuit 18 and when the PAN of the person intersects the circuit 18. Where the apparatus 12 can store the person's profile, the person (not shown in FIG. 5) loads his profile via the data interface 90, and the processor 80 stores the profile in the memory 88. Alternatively, the person may load the profile via the wireless path 90 or the cabled path 94. The memory 88, which may be volatile or nonvolatile, may store the operating program for the processor 80 as well as the person's profile and the identifier that identifies the person to the circuit 18.

The circuit 18 is similar to the circuitry 79 of the apparatus 12, and includes a processor 96, a transmitter/receiver 98 that interfaces the processor with an antenna 100 or connector 102, a memory 104, and an optional data interface 106 such as a key pad or touch screen. The processor 96 receives the identity of a person (not shown in FIG. 5) wearing the apparatus 12 from the processor 80 and recalls the person's profile from the memory 104 as discussed above in conjunction with FIGS. 1-4. The processor 96 can also perform or cause the circuit 18 to perform the other functions described above in conjunction with FIGS. 1-4 such as determining how far the person wearing the apparatus 12 is from the circuit 18 and when the PAN of the person intersects the circuit 18. The processor 96 receives the download of the person's profile from the processor 80 or from the data interface 106 and stores the profile in the memory 104. Alternatively, the processor 80 may receive the download of the profile from another source via the antenna 100 or connector 102. The memory 104 may store the operating program for the processor 96 as well as the downloaded profile. The memory 104 may also store person identifiers so that the processor 96 can recall the correct profile for a particular person.

What is claimed:

1. An electronic apparatus, comprising:
a housing that a person can carry; and
a circuit coupled to the housing that causes a device to operate according to a predetermined user profile of the person, the device being remote from the housing and circuit.

2. The electronic apparatus of claim 1 wherein the circuit provides the user profile to the device.

3. The electronic apparatus of claim 1 wherein the circuit causes the device to operate according to the user profile when the person is within a predetermined distance from the device.

4. The electronic apparatus of claim 1 wherein the circuit communicates with the device via a wireless channel.

5. The electronic apparatus of claim 1 wherein the circuit communicates with the device via a cable.

6. The electronic apparatus of claim 1 wherein the circuit comprises:
a processor;
a memory coupled to the processor and stores the user profile; and
a transmitter coupled to the processor.

7. A device, comprising a circuit that:
stores a predetermined user profile of a person;
detects a remote electronic apparatus associated with the person; and
causes the device to operate according to the user profile in response to detecting the electronic apparatus.

8. The device of claim 7 wherein the circuit receives the user profile from the electronic apparatus.

9. The device of claim 7 wherein the circuit to detects the electronic apparatus when the electronic apparatus is within a predetermined distance from the device.

10. The device of claim 7 wherein the circuit comprises:
a memory that stores the user profile; and
a processor coupled to the memory that causes the device to operate according to the user profile.

11. The device of claim 7 wherein the circuit detects the electronic apparatus via a wireless channel.

12. The device of claim 7 wherein the circuit detects the electronic apparatus via a cable.

13. A base unit, comprising a circuit that:
stores a predetermined user profile of a person;
detects a remote electronic apparatus associated with the person; and
causes a satellite device to operate according to the user profile in response to detecting the electronic apparatus.

14. The base unit of claim 13 wherein the circuit receives the user profile from the electronic apparatus.

15. The base unit of claim 13 wherein the circuit detects the electronic apparatus when the electronic apparatus is within a predetermined distance from the base unit.

16. The base unit of claim 13 wherein the circuit comprises:
a memory that stores the user profile; and
a processor coupled to the memory that causes the satellite device to operate according to the user profile.

17. The base unit of claim 13 wherein the circuit communicates with the electronic apparatus and the satellite device via respective wireless channels.

18. The base unit of claim 13 wherein the circuit communicates with the electronic apparatus and the satellite device via respective cables.

19. The base unit of claim 13 wherein the circuit:
communicates with the electronic apparatus via a wireless channel; and
communicates with the satellite device via a cable.

20. A system, comprising:
a first electronic apparatus operable to be carried by a first person; and
a device that when remote from the electronic apparatus is operable to,
store a first predetermined user profile of the first person,
detect the first electronic apparatus, and
operate according to the first user profile in response to detecting the first electronic apparatus.

21. The system of claim 20 wherein the first electronic apparatus is operable to:
store the first user profile; and
provide the stored first user profile to the device.

22. The system of claim 20 wherein the device is operable to detect the first electronic apparatus when the device is within a predetermined distance from the first electronic apparatus.

23. The system of claim 20, further comprising:
a second electronic apparatus operable to be carried by a second person; and
wherein the device when remote from the second electronic apparatus is operable to,
store a second predetermined user profile of the second person,
detect the second electronic apparatus,
operate according to the first user profile in response to detecting only the first electronic apparatus,
operate according to the second user profile in response to detecting only the second electronic apparatus, and
in response to simultaneously detecting the first and second electronic apparatus, determine respective priorities of the first and second persons and operating according to the user profile of the person having the higher priority.

24. The system of claim 20, further comprising:
a second electronic apparatus operable to be carried by a second person; and
wherein the device when remote from the second electronic apparatus is operable to,
store a second predetermined user profile of the second person,
detect the second electronic apparatus,
operate according to the first user profile in response to detecting only the first electronic apparatus,
operate according to the second user profile in response to detecting only the second electronic apparatus, and
in response to simultaneously detecting the first and second electronic apparatus, operating according to the user profile associated with the electronic apparatus closest to the device.

25. The system of claim 20 wherein the first electronic apparatus comprises a laptop computer.

26. The system of claim 20 wherein the first electronic apparatus comprises a personal digital assistant.

27. The system of claim 20 wherein the device comprises an appliance.

28. The system of claim 20 wherein the device comprises a vending machine.

29. The system of claim 20 wherein the device comprises a seat that is operable to configure itself according to the user profile in response to detecting the first electronic apparatus.

30. A system, comprising:
an electronic apparatus operable to be carried by a person;
a satellite device that is operable to be remote from the electronic apparatus; and
a base unit coupled to the satellite device and that when remote from the electronic apparatus is operable to,
store a predetermined user profile of the person,
detect the electronic apparatus, and
cause the satellite device to operate according to the user profile in response to detecting the electronic apparatus.

31. The system of claim 30 wherein the electronic apparatus is operable to:
store the first user profile; and
provide the stored first user profile to the base unit.

32. The system of claim 30 wherein the base unit is operable to detect the electronic apparatus when the base unit is within a predetermined distance from the electronic apparatus.

33. The system of claim 20 wherein the base unit comprises a personal computer.

34. A method, comprising:
sensing a person associated with a user profile; and
configuring a device according to the user profile in response to sensing the person.

35. The method of claim 34, further comprising:
the person carrying an electronic apparatus; and
wherein configuring the device comprises configuring the device with the electronic apparatus.

36. The method of claim 34, further comprising:
connecting an electronic apparatus to the device; and
wherein configuring the device comprises configuring the device with the connected electronic apparatus.

37. The method of claim 34 wherein sensing the person comprises sensing the person when the person is within a predetermined distance from the device.

38. The method of claim 34, further comprising:
the person carrying an electronic apparatus; and
wherein sensing the person comprises sensing the electronic apparatus.

39. The method of claim 34 wherein:
sensing the person comprises sensing the person with a base unit; and
configuring the device comprises configuring the device with the base unit.

40. The method of claim 34 wherein:
sensing the person comprises sensing the person with the device; and
configuring the device comprises causing the device to configure itself.
